(19) United States
(12) Patent Application Publication
(10) Pub. No.: US 2016/0047435 A1
(43) Pub. Date: Feb. 18, 2016

(54) DAMPER DEVICE FOR A VEHICLE AND METHOD FOR DESIGNING A DAMPER DEVICE

(71) Applicant: SCHAEFFLER TECHNOLOGIES AG & CO. KG, Herzogenaurach (DE)

(72) Inventors: Benjamin Voegtle, Karlsruhe (DE); Yannick Strub, Roeschwoog (FR)

(21) Appl. No.: 14/781,708

(22) PCT Filed: Mar. 19, 2014
(86) PCT No.: PCT/DE2014/200132

§ 371 Date: Oct. 1, 2015

(30) Foreign Application Priority Data
Apr. 2, 2013 (DE) 10 2013 205 802.0
Apr. 8, 2013 (DE) 10 2013 005 872.4
Apr. 8, 2013 (DE) 10 2013 206 155.2
Dec. 6, 2013 (DE) 10 2013 225 060.6
Feb. 19, 2014 (DE) 10 2014 203 012.9
Feb. 19, 2014 (DE) 10 2014 203 016.1

(51) Int. Cl. F16F 15/123; F16F 15/14; F16H 45/02; F16D 3/12

(52) U.S. Cl. CPC F16F 15/12366; F16D 3/12; F16F 15/145; F16H 45/02; F16H 2045/0263; F16H 2045/0231

(57) ABSTRACT

A damper device, preferably for a torque converter of a motor vehicle, for transferring torque between a drive side and output side of the device, having an input element which is rotatable to a limited degree in relation to an intermediate element which is located after the input element in a torque transfer path through an effect of a first energy storage element, while forming a first damper stage, and an output element located after the intermediate element in the torque transfer path, which is rotatable to a limited degree in relation to the intermediate element through an effect of a second energy storage element, while forming a second damper stage, wherein the damper device, or the first damper stage and/or the second damper stage is designed in such a way that the first damper stage and/or the second damper stage can essentially be short-circuited mechanically by means of bridging.

### CROSS-REFERENCE TO RELATED APPLICATIONS

The present application is the U.S. national stage application pursuant to 35 U.S.C. 371 of international Application No. PCT/DE2014/200132, filed Mar. 19, 2014, which application claims priority of German Application No. 10 2013 205 802.0 filed Apr. 2, 2013, German Application No. 10 2013 005 872.4 filed Apr. 8, 2013, German Application No. 10 2013 206 155.2 filed Apr. 8, 2013, German Application No. 10 2013 225 060.6 filed Dec. 6, 2013, German Application No. 10 2014 203 012.9 filed Feb. 19, 2014 and German Application No. 10 2014 203 016,1 filed Feb. 19, 2014.

### TECHNICAL FIELD

The present invention relates to a damper device, in particular a torsional vibration damper, for a motor vehicle, preferably for a torsion transfer device or converter of a motor vehicle, for transferring a torque between a drive side and an output side of the damper device. Furthermore, the invention relates to a torque transfer device or a converter, in particular a hydrodynamic torque converter for a vehicle, preferably for a drivetrain of a motor vehicle. In addition, the invention relates to a method for designing a damper device, in particular a torsional vibration damper.

### BACKGROUND

On a crankshaft of a periodically operating internal combustion engine of a motor, vehicle, superimposed non-uniformities of rotation occur during rotation of the crankshaft when the motor vehicle is in operation, their nature and/or frequency changing with the speed of the crankshaft. Comparatively severe non-uniformities of rotation develop during operation of the motor vehicle as torque of the internal combustion engine changes, i.e., as the demand for torque from a driver of the motor vehicle changes. Furthermore, torsional vibrations are excited in the drivetrain of the motor vehicle by combustion processes in the internal combustion engine, in particular in traction mode. To reduce the severe non-uniformities of rotation in the drivetrain, a torsional vibration damper may be utilized, whereas a centrifugal pendulum device is able essentially to eliminate the periodic torsional vibrations in the drivetrain of the motor vehicle over a comparatively large speed range of the internal combustion engine.

Torsional vibration dampers are utilized as damper devices, in particular between the internal combustion engine and a transmission of the motor vehicle. Torsional vibration dampers are employed, for example, in/on torque converters, clutch plates of friction clutches or as dual-mass flywheels.—A torque converter having, for example, torsional vibration damper devices connected in series and a centrifugal pendulum device, along with the internal combustion engine and the drivetrain of the vehicle, represents a vibration system. The natural modes of this vibration system are excited on the basis of the rotational non-uniformities of the internal combustion engine. The natural frequencies of the vibration system are a function of the torsional rigidities and the rotating masses in the vibration system.

Under the conditions of the system, the excitations in the vehicle and the centrifugal pendulum device result in a natural mode of vibration which may lie in a drivable range, in particular in 4-cylinder applications. In the present damper concept—dual turbine damper with centrifugal pendulum device—a frequency of this natural mode is decisively dependent on a rigidity of a second damper stage of the torsional vibration damper, i.e., the stiffness between a turbine of the torque converter or the centrifugal pendulum device and an output side of the damper device. In the existing art, the attempt is made to shift the natural mode to below the drivable range (using the softest possible second damper stage). But, since at the same time the damper device is supposed to cover an entire engine torque, reduction of a stiffness of the second damper stage is limited.

### SUMMARY

One object of the invention is to specify an improved damper device, in particular an improved torsional vibration damper, for a vehicle, preferably for a torque transfer device or a converter of a motor vehicle, as well as a torque transfer device or a converter having a damper device that is improved in this way. Furthermore, it is an object of the invention to specify a method for designing a damper device, in particular a torsional vibration damper, for a vehicle. According to the invention, it should be possible to shift a normal mode of vibration which lies in a drivable range to below the drivable range. At the same time, the damper device should be constructed simply, or an already existing damper device should be capable of being correspondingly converted simply, without comparatively expensive design features.

The object of the invention is fulfilled by means of a damper device, in particular a torsional vibration damper, fir a vehicle, preferably tier a torque transfer device or converter of a motor vehicle; by means of a torque transfer device or a converter, in particular a hydrodynamic torque converter, for a vehicle, preferably for a drive train of a motor vehicle; and by a method for designing a damper device, in particular a torsional vibration damper. Advantageous refinements, additional features and/or advantages of the invention derive from the subordinate claims and a following description.

The damper device according to the invention comprises an input element, which, through an effect of a first energy storage element, is rotatable to a limited degree in relation to an intermediate element which is positioned after the input element in a torque transfer path, while forming a first damper stage, and an output element positioned after the intermediate element in the torque transfer path, which, through an effect of a second energy storage element, is rotatable to a limited degree in relation to the intermediate element, while forming a second damper stage. According to the invention, the damper device or the first and/or the second damper stage is designed in such a way that the first and/or the second damper stage can essentially be short-circuited mechanically by means of a bridging.

The damper device is thus operable as either a dual or a single damper device, depending on a torque being applied to it, in particular an engine torque. This means, for example, that a single damper device is operable initially as a dual damper device, if the torque being applied is comparatively small. If this torque rises to a certain value (transitional torque), which corresponds to a certain torsional angle of the damper device, the mechanical bridging short-circuits a damper stage; that is, it bridges this damper stage, so that above the certain torque value this damper device is only operable as a single damper device. If the torque drops below the certain value, the bridging of this damper stage is released again and the damper device again operates as a dual damper device. The damper device is designed as a partial dual damper device.

In preferred embodiments of the invention, the construction of the damper device is designed so that an energy storage element of the second damper stage, or the second damper stage, is bridgeable by means of a mechanical stop on/in the damper device or the second damper stage. In this case, only the second damper stage may have a mechanical stop, in particular a fixed stop or a spring stop. Furthermore, the damper device may be designed so that an energy storage element of the first damper stage, or the first damper stage, is bridgeable by means of a stop on/in the damper device or the first damper stage. In addition, the damper device may be designed so that the first damper stage and the second damper stage are jointly bridgeable by means of a stop between the first damper stage and the second damper stage.

Naturally, it is possible to design the damper device so that only the energy storage element of the first damper stage, or the first damper stage, is mechanically bridgeable; or to design the damper device so that only the energy storage element of the second damper stage, or the second damper stage, is mechanically bridgeable; or to design the damper device so that both the energy storage element of the first damper stage, or the first damper stage, as well as also the energy storage element of the second damper stage, or the second damper stage, are mechanically bridgeable, in which case any mass damper device that is present remains in effect. Furthermore, the damper device may be designed so that the first damper stage and the energy storage element of the second damper stage are bridgeable simultaneously, or the damper device may be designed so that the input element is mechanically bridgeable together with the output element, while any mass damper device that is present likewise remains in effect.

According to the invention, the construction of the damper device or of the second damper stage may be designed by means of mechanical stopping means in such a way that when a first certain torsional angle or engine torque (transitional torque) is reached between the input element and the output element, or between the intermediate element and the output element, the energy storage element of the second damper stage is mechanically bridgeable, or the second damper stage bridges itself. Furthermore, the construction of the damper device or the first damper stage may be designed in such a way that by means of the first damper stage, when the first certain torsional angle or engine torque (transitional torque) is exceeded, a further rotation between the input element and the output element, or between the input element and the intermediate element, is possible.

According to the invention, the construction of the damper device or of the first damper stage may be designed by means of mechanical stopping means in such a way that when a second certain torsional angle or engine torque (transitional torque) is reached between the input element and the output element, or between the input element and the intermediate element, the energy storage element of the first damper stage is mechanically bridgeable, or the first damper stage bridges itself. Furthermore, the damper device, the first damper stage or the second damper stage may be designed by means of damping means in such a way that when the second certain or a third certain torsional angle or engine torque is reached between the input element and the output element, or between the input element and the intermediate element, they are mechanically bridgeable and/or bridge themselves.

In embodiments of the invention, the bridging or mechanical stop may be implemented by means of a maximum compression of an energy storage element. Furthermore, the bridging may be implemented through stopping means, where stopping means are designed as a fixed stop and/or stopping means are designed as a spring stop. The intermediate element may have a mass damper device, which is designed in particular as a centrifugal pendulum device, preferably as a rotational-speed-adaptive centrifugal pendulum device. The mass damper device may be designed as an absorber mass element, having an absorber mass carrier which receives the latter. In particular, the absorber mass element is pivotable to a limited degree in relation to the absorber mass carrier.—According to the invention, a certain torsional angle results from a certain engine torque and the spring rates of the involved energy storage elements.

According to the invention, a spring rate of the second energy storage element may be lower than a spring rate of the first energy storage element. Preferably, a spring stop means of the second damper stage is designed as an overload protection. In this case, it is preferred that the energy storage element of the overload protection has a highest spring rate among the energy storage elements.—To the first damper stage and/or to the second damper stage, a third damper stage of the damper device may be connected, acting in parallel and/or in series. Preferably, the intermediate element is designed as a mass element, in particular as a turbine wheel. That is, the damper device may be designed as a turbine damper device, in particular a dual turbine damper device.

The method according to the invention for designing a damper device for transmitting a torque between a drive side and an output side of the damper device comprises the steps of designing the damper device below a certain transitional torque coming from the drive side as a damper device having two functional damper stages, and designing the damper device above the certain transitional torque coming from the drive side as a damper device having a single functional damper stage. Preferably, the damper device below the certain transitional torque of the drive side is conceived as a dual turbine damper device, and above the certain transitional torque of the drive side as a single turbine damper device.

According to the invention, a second damper stage of the damper device may be designed as a dual damper stage and/or a first damper stage of the damper device may be designed as a dual damper stage. Such a dual damper stage may be realized using two different energy storage elements in the relevant damper stage. According to the method according to the invention, the damper device may be designed for conventional operation of the vehicle with an internal combustion engine, operation of the vehicle with cylinder shut-off of the internal combustion engine, and/or operation of the vehicle with an electric motor. Such a damper device may be designed as a damper device according to the invention, in particular as a torsional vibration damper according to the invention.

### BRIEF DESCRIPTION OF THE DRAWINGS

The invention will be explained in greater detail in the following section on the basis of exemplary embodiments, with reference to the appended drawing. Elements or components which have an identical, unambiguous or analogous design and/or function are identified in the various figures of the drawing by the same reference label. The nature and mode of operation of the present disclosure will now be more fully described in the following detailed description of the present disclosure taken with the accompanying figures, in which:

FIG. 1 is a schematic depiction of a first embodiment of a damper device according to the invention for a torque transfer device according to the invention;

FIG. 2 is a schematic depiction of a second embodiment of the damper device according to the invention;

FIG. 3 is a schematic depiction of a third embodiment of the damper device according to the invention; and,

FIG. 4 is a plurality of characteristic curves of a damper device according to the invention of another embodiment of the invention.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

The description of the invention relates below to an axial direction Ax, an axis of rotation Ax, a radial direction Ra and a circumferential direction Um of a torque transfer device 10 of a vehicle, in particular a motor vehicle having a gasoline or diesel engine. These indications of position also relate, for example, to a crankshaft, a drivetrain, the torque transfer device 10, a clutch, a clutch device, a damper 10, a damper device 10, a mass damper device 30, a converter and/or a transmission of the motor vehicle.

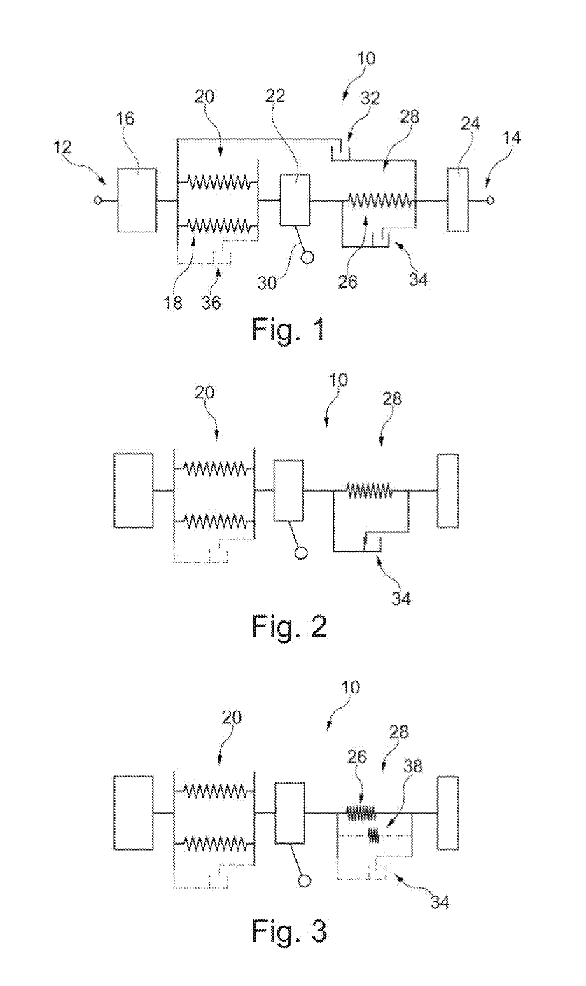

The torque transfer devices 10 depicted in FIGS. 1 through 3 or the converters 10 depicted there each have a damper device 11 according to the invention or a damper 11 according to the invention, preferably designed as a torsional vibration damper 11, which preferably is designed as a turbine damper device 11. The torque transfer device 10 or the converter 10 having the damper device 11 may comprise, for example, a hydrodynamic torque converter, a dry-running or wet-running clutch device or a (multiple) clutch, a dual-mass flywheel, a damper device, a damper or a combination thereof.

The mechanical equivalent circuit diagrams of FIGS. 1 through 3 represent examples of damper devices 11, in which according to the invention at least one damper stage 20, 28 of the relevant damper device 11 is bridgeable. That is, the relevant damper stage 20, 28 may preferably become or be essentially short-circuited mechanically, depending on a torsional angle 42. The torsional angle 42 itself corresponds to a rotational or engine torque present on the damper device 11. With a certain engine torque present (see below a transitional torque 40), a relevant spring rate—spring constant—assumes very high values (see below a spring stop 38) or goes toward infinity (see below a fixed stop 32, 34, 36 or a maximum compression of an energy storage element 18, 26, 38).

Applicable bridgings according to the invention (at items 18, 26, 32, 34, 36, 38) to mechanically short-circuit the relevant damper stage(s) 20, 28 are briefly presented below without attention to a specific depicted embodiment. According to the invention, a damper device 11 may have any mereological number of one or more of the bridgings. Preferably, the damper stage (28) which is designed as a softest damper stage (28) is bridgeable here. Naturally, the invention is also transferable, etc. (38) to the second-softest damper stage (20).

For example, a first damper stage 20 may be or become mechanically short-circuited by means of a mechanical fixed stop 36 (FIGS. 1 through 3, optional) and/or at a maximum compression of their energy storage element 18 (FIGS. 1 through 3) (spring rate infinite or very great). Furthermore, a second damper stage 28 may be or become mechanically short-circuited by means of a mechanical fixed stop 34 (FIGS. 1 through 3) and/or at maximum compression of their energy storage element 26 (FIG. 3). In addition, both damper stages 20, 28 may be or become mechanically short-circuited simultaneously by means of a mechanical fixed stop 32 (FIG. 1) and/or at maximum compression of all involved energy storage elements 18, 26, (38) (FIG. 3).

In this case, a respective mechanical fixed stop 32, 34, 36 may be constituted by mutually corresponding and/or complementary stopping means 32, 34, 36, where the respective stopping means 32, 34, 36 for the most part comprise one or two devices which prevent a reciprocal rotational motion of the particular elements or components starting from or at the corresponding torsional angle 42 or transitional torque 40. That is, the particular elements or components block each other, with preferably one element or component being placeable, supportable or collectible on the respective other one, for example by means of a projection. The other element or component may have a mating surface, which for its part is formed, for example, on a projection.

In this case, the particular energy storage element 18, 26, 38 may comprise at least one coil spring 18, 26, 38, preferably conceived as a compression spring 18, 26, 38. Preferably, for each energy storage element 18, 26, 38 at least two, three, four or more coil springs 18, 26, 38 are used, where in particular a linear spring 18, 26, 38 or bow spring 18, 26, 38 may be used as a coil spring 18, 26, 38. Naturally, a combination of a linear spring 18, 26, 38 with a bow spring 18, 26, 38 is usable within an energy storage element 18, 26, 38.

So, according to FIG. 1, an input element 16 and an output element 24 of the damper device 11 may have corresponding or complementary fixed stopping means 32. If these elements 32 are in close contact with each other, then both damper stages 20, 28 are blocked. The input element 16 is designed, for example, as an input flange 16 or a lateral part 16, etc., and/or the output element 24 is designed, for example, as an output flange 24, a hub flange 24 or a lateral part 24, etc. The corresponding or complementary fixed stopping means 34 according to FIGS. 1 through 3 may be designed on/in an intermediate element 22 and the output element 24 of the damper device 11. If these elements 34 are in close contact with each other, then the second damper stage 28 is blocked. The intermediate element 22 is designed, for example, as a connecting element 22, a mass element 22 or an intermediate flange 22, etc.

Furthermore, according to FIGS. 1 through 3, the input element 16 and the intermediate element 22 of the damper device 11 may have the corresponding or complementary fixed stopping means 36. If these elements 36 are in close contact with each other, then the first damper stage 20 is blocked. FIG. 3 shows a spring stopping means 38, which is formed of the intermediate element 22, an energy storage element 38 and the output element 24. If a stop of the intermediate element 22 bumps into the energy storage element 38 and the latter bumps into a stop of the output element 24, then the second damper stage 28 is blocked. The energy storage element 38 may be designed here as an overload protection. That is, the energy storage element 38 may be capable of being compressed when a comparatively high damper torque occurs.

The spring stops of the first damper stage 20 and the second damper stage 28 can be conceived analogously to the fixed stops. So, if the first energy storage element 18 is completely compressed, then the first energy storage element 18 sits firmly clamped between the input element 16 and the intermediate element 22, whereby the first damper stage 20 is blocked—that is, bridged. At the same time, in particular the relevant spring sections of the compression springs of the energy storage element 18 are in close contact with each other. So, if the second energy storage element 26 is completely compressed, then the second energy storage element 26 sits firmly clamped between the intermediate element 22 and the output element 24, whereby the second damper stage 20 is blocked.

In some embodiments of the invention, the input element 16 may be located, for example, after an activatable clutch in a torque transfer path between the drive side 12 and the output side 14. Furthermore, or alternatively, the output element 24 may be located in the torque transfer path ahead of an (additional) activatable clutch or clutch device. The first damper stage 20 and the second damper stage 28 may be positioned in a housing that accommodates fluid, and/or coupled mechanically therewith. Furthermore, the first damper stage 20 and the second damper stage 28 may be located outside of this housing.

The depicted embodiments are explained in greater detail below; components depicted with dashed tines are optionally usable. FIG. 1 shows a damper device 11 according to the first embodiment for transmitting a torque between a drive side 12, for example a drive component, in particular of an internal combustion engine and/or an electric motor, and an output side 14, for example a transmission. The damper device 11 comprises the first damper stage 20 and the second damper stage 28. In a first damper stage 20, the input element 16 is rotatable to a limited degree in relation to the intermediate element 22, mediated by a torsional rigidity of the first energy storage element 18. In the second damper stage 28, the intermediate element 22 is likewise rotatable to a limited degree in relation to the output element 24, mediated by a torsional rigidity of the second energy storage element 26.

According to the first embodiment, the second damper stage 28 is bridgeable. The second damper stage 28 is preferably bridgeable in such a way that an additional relative rotation between the intermediate element 22 and the output element 24 is not possible, or is possible only with a greatly increased expenditure of force in comparison to a spring effect of the second damper stage 28 (overload protection see below, energy storage element 38). A mass damper device 30, which comprises in particular a rotational-speed-adaptive centrifugal pendulum 30, may be attached to the intermediate element 22. The centrifugal pendulum 30 preferably comprises a pendulum mass carrier and limitedly pivotable pendulum masses located thereon, which are pivotable in relation to the pendulum mass carrier along pendulum paths. Preferably, the intermediate element 22 functions as a pendulum mass carrier, or the pendulum mass carrier is attached to the intermediate element 22. There may be an additional mass damper device located in the torque transfer path before and/or after and/or on the intermediate element 22.

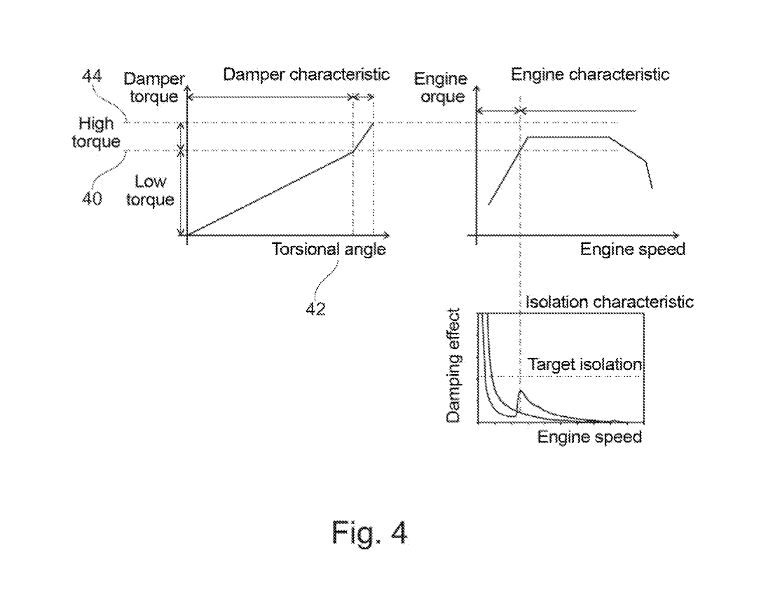

The second damper stage 28 is preferably bridged when a first certain torsional angle 42 (see FIG. 4 at transitional torque 40) between the input element 16 and the output element 24 is reached. In particular, below the torque coming from the drive side, for example the engine torque, defined as transitional torque 40 (see FIG. 4), the first damper stage 20 and the second damper stage 28 are operative; therefore the second damper stage 28 is not bridged (also see FIG. 4). When the transitional torque 40 is reached or exceeded, the second damper stage 28 is bridged, and thus it is as if the intermediate element 22 were rigidly connected to the output element 24 in the direction of rotation, circumventing the effect of the second damper stage 28.

One benefit is that the second energy storage element 26 (helical compression springs 26) of the second damper stage 28 can be designed for a lower input-side torque, whereby it can have in particular a lower spring rate than the first energy storage element 18 (helical compression springs 18). This measure can shift a critical natural mode of vibration in the operation of the damper device 11 below the transitional torque 40 to lower speeds of rotation, preferably out of a drivable range of the vehicle. When the transitional torque 40 is reached and exceeded (see FIG. 4), an input speed in particular is also higher, and thus the vibration excitation is smaller. As a result, the mass damper device 30 can advantageously operate more effectively, whereby adequate vibration damping is achievable with the second damper stage 28 bridged.

When the first certain torsional angle 42 is reached and exceeded (at transitional torque 40), the first damper stage 20 enables an additional rotation between the input element 18 and the output element 24. Advantageously, the first damper stage 20 is bridged between the input element 18 and the output element 24 when a second torsional angle 42 is reached, which is in particular larger than the first certain torsional angle 42. In addition or alternatively, when the second or a third certain torsional angle between the input element 18 and the output element 24 is reached, the first damper stage 20 and the second damper stage 28 may be bridged, preferably by stopping means 32 operating parallel to both damper stages 20, 28.

A bridging may be brought about by stopping means 34, 36, which enable, for example, a relative rotation of relevant elements 16, 22, 24 up to a maximum torsional angle (at maximum torque 44), and cause a limitation of further rotation of the relevant elements 16, 22, 24 when this torsional angle 42 is reached. Alternatively or in addition, the respective energy storage element 18, 26 can cause a bridging by reaching a maximum compression. In particular, when the damper device 11 is designed as a hydrodynamic torque converter, the intermediate element 22 comprises the turbine wheel. The intermediate element 22 may also include an additional mass element.

FIG. 2 shows the second embodiment of the damper device 11, wherein the damper device 11 is depicted in a state in which the transitional torque 40 is reached and the stopping means 34 cause bridging of the second damper stage 28. A possible spring moment of the first damper stage 20 may be greater than the maximum spring moment of the second damper stage 20 (excluding stop stage). This damper device 11 comprises mechanically vibration-capable connection of the input element 18 to the intermediate element 22 through the first damping stage 20 and an optional stop 36. Furthermore, the damper device 11 has a mechanically vibration-capable connection of the intermediate element 22 to the output element 24 through the second damper stage 28 with the stop 34. An additional spring element 38 with a high stiffness, which may serve as an overload protection, can be used (see FIG. 3).

FIG. 3 shows the third embodiment of the damper device 11, wherein the damper device 11 comprises mechanically vibration-capable connection of the input element 18 to the intermediate element 22 through the first damper stage 20 and an optional stop 36. Furthermore, the damper device 11 has a mechanically vibration-capable connection of the intermediate element 22 to the output element 24 through the second damper stage 28 with the optional stop 34. Furthermore, a connection of the intermediate element 22 to the output element 24 through the second damper stage 28 with an optional stop stage may be used. This is, for example, an additional spring element (38) having a high stiffness, which may serve as an overload protection. A possible spring moment of the first damper stage 20 may in turn be greater than the maximum spring moment of the second damper stage 20 (excluding stop stage).

If no stop 36 is used, then the bridging of the first damper stage 20 may be causable by a maximum compression of the first energy storage element 18. Furthermore, if no stop 34 is used, then the bridging of the second damper stage 28 may be causable by a maximum compression of the second energy storage element 26. It is naturally possible in the damper device 11 to combine the stop 36 (bridging of the first damper stage 20) with a bridging of the second damper stage 28 through a maximum compression of the second energy storage element 26. Furthermore, it is naturally possible in the damper device 11 to combine the stop 34 (bridging of the second damper stage 20) with a bridging of the first damper stage 28 through a maximum compression of the first energy storage element 18.

FIG. 4 shows characteristic curves of a damper device 11 ifs another embodiment of the invention. Here, a damper characteristic curve shows the damper torque plotted over the torsional angle 42 between the input element 16 and the output element 24. When the transitional torque 40 is reached, corresponding to a first certain torsional angle 42, a bridging of the second damper stage occurs, whereupon the characteristic runs more steeply at a greater torsional angle 42. When a maximum torque 44 is reached, the first damper stage 20 is also bridged, whereupon in particular no further rotation occurs between the input element 16 and the output element 24. In such a case, the input element 16 is rigidly connected to the output element 24 in the direction of rotation. An engine characteristic curve depicts a course of the engine torque as a function of the engine speed. In this case, the transitional torque 40 corresponds to a certain engine speed. An isolation characteristic curve illustrates the damping effect as a function of the engine speed.

As can be seen in FIGS. 1 through 3, in each case in conjunction with FIG. 4, the damper device 11 operates below a defined engine torque (engine torque lower than transitional torque 40) as a dual damper device 11, preferably with a mass damper device 30. The second damper stage 28 is blocked at a certain engine torque (engine torque greater than transitional torque 40), and the intermediate element 22 is thereby linked to the output element 24. The second damper stage 28 can be designed here for a lower torque (transitional torque 40), whereby a lower spring rate for the second energy storage element 26 results than in the existing art, which shifts the critical mode of vibration when operating as a dual damper device 11 to lower speeds of rotation.

At an engine torque which is greater than the transitional torque 40, the damper device 11 designed as a series damper 11 or series damper device 11 operates as a single damper device 11, preferably with a mass damper device 30. Since, at this torque, the engine speed is also greater, the excitations are less intense and the mass damper device 30 works more effectively, an isolation effect of the single damper device 11 is sufficient. The damper device 11 operates according to the invention partially as a dual damper device 11 and partially as a single damper device 11.

By means of different spring rates in the first damper stage 20 compared to the second damper stage 28, and by means of fixing a damper stage 20/28 or both damper stages 20, 28, in particular by fixing the second damper stage 28 in relation to the first damper stage 20, by means of sensible attachment of stops 32, 34, 36, 38 or stopping means 32, 34, 36, 38 on/in the relevant elements 16, 22, 24 of the damper device 11 there occurs a change of the damper device 11 from a dual damper device 11 to a single damper device 11, in each case preferably having a mass damper device 30, depending on whether the internal combustion engine offers a high or a low torque. The objective here is to have to design the second damper stage 28 only for up to a transitional torque 40 and thereby to be able to lower its spring rate, which has a positive effect on the vibration isolation.

With a low engine torque present at the damper device 11 (torque of the internal combustion engine is lower than the transitional torque 40), both damper stages 20, 28 are vibration-capable and the intermediate element 22 vibrates between the two damper stages 20, 28. Due to the low spring rate of the second damper stage 28, which is designed only for the transitional torque 40, the critical natural mode lies outside of the drivable range. With a low engine torque present at the damper device 11 (torque of the internal combustion engine is higher than the transitional torque 40), the second damper stage 28 goes to blocking This links the intermediate element 22 to the output element 24, and the critical natural mode of vibration of the second damper stage 28 is no longer present.

For example, when the invention is applied to a hydrodynamic torque converter 10, at a high engine speed—i.e., high torque delivered by the internal combustion engine, which is greater than the transitional torque 40—the turbine 22 is linked to the output element 24, preferably with a mass damper device 30. The damper device 11 operates as a single turbine damper device 11. At low speed, i.e., a lower torque delivered by the internal combustion engine, which is lower than the transitional torque 40, that is, in the range of the critical natural mode of the damper device 11, the damper device 11 operates as a dual turbine damper device 11, preferably with a mass damper device 30. The critical natural mode is shifted to lower rotational speeds by the softer second damper stage 28 now active.

According to the invention, a (mechanical) bridging or (mechanical) short circuiting of the damper device 11 or of the first damper stage 20 and/or the second damper stage 28 is to be understood to mean the following. The vibration-capable damper device 11, according to the invention the vibration-capable damper stages 20, 28, the vibration-capable first damper stage 20 and/or the vibration-capable second damper stage 28 can be crippled, i.e., switched to passive, depending on a torque present at the damper device 11 or between the input element 16, the intermediate element 22 and/or the output element 24, which can rotate the involved elements 16, 22, 24 of the damper device 11 relative to each other in the circumferential direction Um of the damper device.

This passive switching according to the invention of the damper device 11 or the first damper stage 20 and/or the second damper stage 28 preferably takes place only in the direction of the occurring torque, where a relevant unit 11, 20, 28; 20, 28; 20; 28 is no longer vibration-capable as long as the torque exceeds a certain value, the so-called transitional torque 40 at a certain torsional angle 42. That is, depending on the torque the relevant unit 11, 20, 28; 20, 28; 20; 28 is functional or non-functional, on or off, flexible or rigid, vibration-capable or non-vibration-capable, or active or passive. If the relevant unit 11, 20, 28; 20, 28; 20; 28 is not functional (single damper device 11), then at least two elements 16, 22, 24 of the damper device 11 are rigidly coupled mechanically in the direction of rotation of the damper device 11, or the relevant unit 11, 20, 28; 20, 28; 20; 28 is mechanically bridged—that is, short circuited or blocked.

According to the invention a (partial dual) damper device 11 or a (partial dual) damper 11 results, which, on the basis of its construction with regard to a torque-dependent concept, is advantageously designed with a connected stop and associated spring geometry with regard to vibration isolation.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE LABELS

10 torque transfer device, converter for a vehicle, in particular for a drivetrain of a motor vehicle—for example a hydrodynamic torque converter, dry-running or wet-running clutch device or (multiple) clutch, dual-mass flywheel, damper device, damper, combination thereof, etc. or damper device, damper or torsional vibration damper having a torque transfer device, converter, hydrodynamic torque converter, dry-running or wet-running clutch device or (multiple) clutch, dual-mass flywheel, combination thereof, etc.
11 (partial dual) damper device, damper or torsional vibration damper for a vehicle, in particular for a drivetrain of a motor vehicle, series damper device, spring-mass system, in particular a turbine damper device, preferably a dual turbine damper device
12 drive side of the damper device 11 or torque transfer device 10, engine, clutch, input side/part of the damper device 11
14 output side of the damper device 11 or torque transfer device 10, clutch, transmission, output side/part of the damper device 11
16 input element/part of the damper device 11, damper (input) part, input flange, lateral part
18 (first) energy storage element, in particular having (helical) compression springs, preferably at least one linear and/or bow spring, (spring) stop, stopping means, torsional rigidity
20 (first) damper stage of the damper device 11
22 intermediate element/part, connecting element/part, mass element/part, damper (intermediate) part, intermediate flange, for example rotating mass, turbine possibly having mass damper device 30, turbine wheel
24 output element/part of the damper device 11, damper (output) part, output flange, hub flange, lateral part
26 (second) energy storage element, in particular having (helical) compression springs, preferably at least one linear and/or bow spring, (spring) stop, stopping means, torsional rigidity
28 (second) damper stage of the damper device 11
30 mass damper device, for example a torsional pendulum device, preferably rotational-speed-adaptive
32 (mechanical) (fixed) stop (stopping means), optional
34 (mechanical) (fixed) stop (stopping means), optional
36 (mechanical) (fixed) stop (stopping means), optional
38 (mechanical) (spring) stop (stopping means), with energy storage element, overload protection, torsional rigidity, optional
40 transitional torque (corresponds to a torsional angle 42)
42 torsional angle (corresponds to a rotational/engine torque)
44 maximum torque (corresponds to a torsional angle 42)
Ax axial direction, axis of rotation, crankshaft, drivetrain, torque transfer device 10, clutch, clutch device, damper, damper device 11, mass damper device 30, converter and/or transmission, etc., axial
Ra radial direction, crankshaft, drivetrain, torque transfer device 10, clutch, clutch device, damper, damper device 11, mass damper device 30, converter and/or transmission etc., radial
Um circumferential direction, crankshaft, drivetrain, torque transfer device 10, clutch, clutch device, damper, damper device 11, mass damper device 30, converter and/or transmission, etc., (relative) rotary motions take place in the circumferential direction Um

1-12. (canceled)

13. A damper device, in particular a torsional vibration damper (11), for a vehicle, preferably for a torque transfer device (10) or a converter of a motor vehicle, for transferring a torque between a drive side (12) and an output side (14) of the damper device (14), having an input element (16), which, through an effect of a first energy storage element (18), is rotatable to a limited degree relative to an intermediate element (22) which is located after the input element (16) in a torque transfer path, while forming a first damper stage (20); and,
an output element (24) located after the intermediate element (22) in the torque transfer path, which is rotatable to a limited degree relative to the intermediate element (22) through an effect of a second energy storage element (26) while forming a second damper stage (28), wherein the damper device (11) or the first damper stage (20) and/or the second damper stage (28) is designed in such a way that the first damper stage (20) and/or the second damper stage (20) can essentially be short-circuited mechanically by means of a bridging.

14. The damper device recited in claim 13, wherein an energy storage element (26) of the second damper stage (28), or the second damper stage (28), is bridgeable by means of a mechanical stop (26, 34, 38) on/in the damper device (11) or the second damper stage (28).

15. The damper device recited in claim 13, wherein an energy storage element (18) of the first damper stage (20), or the first damper stage (20), is bridgeable by means of a mechanical stop (18, 36) on/in the damper device (11) or the first damper stage (20), and/or the damper device (11) is furthermore designed in such a way that the first damper stage (20) and the second damper stage (28) are jointly bridgeable by means of a stop (18, 26; 32) between the first damper stage (20) and the second damper stage (28).

16. The damper device recited in claim 13, wherein the damper device (11) and the second damper stage (28) function by means of mechanical stopping means (26, 34, 38) in such a way that when a first certain torsional angle (42) between the input element (16) and the output element (24), or between the intermediate element (22) and the output element (24) is reached, the energy storage element (26) of the second damper stage (28) or the second damper stage (28) is mechanically bridgeable or bridges itself.

17. The damper device recited in claim 13, wherein the damper device (11) and the first damper stage (20) function in such a way that by means of the first damper stage (20), when the first certain torsional angle (42) is exceeded, a further rotation is possible between the input element (16) and the output element (24), or the input element (16) and the intermediate element (22).

18. The damper device recited in claim 13, wherein the damper device (11) and the first damper stage (20) function by means of mechanical stopping means (18, 36) in such a way that when a second certain torsional angle (42) between the input element (16) and the output element (24), or between the input element (16) and the intermediate element (22) is reached, the first damper stage (20) is mechanically bridgeable or bridges itself.

19. The damper device recited in claim 13, wherein the damper device (11), the first damper stage (20) and the second damper stage (28) function by means of stopping means (18, 26, 32, 34, 36, 38) in such a way that when the second certain or a third certain torsional angle (42) between the input element (16) and the output element (24), or between the input element (16) and the intermediate element (22) is reached, the first damper stage (20) and the second damper stage (28) are mechanically bridgeable or bridge themselves.

20. The damper device recited in claim 13, wherein the bridging can be implemented by means of a maximum compression of an energy storage element (18, 26, 38), and/or the bridging can be implemented through stopping means (32, 34, 36, 38), where the stopping means (32, 34, 36) are designed as a fixed stop (32, 34, 36) and/or the stopping means (38) is designed as a spring stop (38).

21. The damper device recited in claim 13, wherein the intermediate element (22) has a mass damper device (30), which is designed in particular as a centrifugal pendulum device (30), preferably as a rotational-speed-adaptive centrifugal pendulum device (30); only the second damper stage (28) has a mechanical stop (34, 38), in particular a fixed stop (34); a certain torsional angle (42) results from a certain engine torque and the spring rates of the relevant energy storage elements (18, 26, 38); a spring rate of the second energy storage element (26) is lower than a spring rate of the first energy storage element (20); the stopping means (38) of the second damper stage (28) is designed as an overload protection (38); the energy storage element (38) has a highest spring rate among the energy storage elements (18, 26, 38); to the first damper stage (20) and/or to the second damper stage (28), a third damper stage of the damper device (11) is connected, acting in parallel and/or in series; the intermediate element (22) is designed as a mass element (22), in particular as a turbine wheel (22); and/or the damper device (11) is designed as a turbine damper device (11), in particular a dual turbine damper device (11).

22. A torque transfer device or converter, in particular a hydrodynamic torque converter (10), for a vehicle, preferably for a drivetrain of a motor vehicle, wherein the torque transfer device (10) or the converter (10) has a damper device (11), in particular a torsional vibration damper (11), comprising:
a torsional vibration damper (11), for a vehicle, preferably for a torque transfer device (10) or a converter of a motor vehicle, for transferring a torque between a drive side (12) and an output side (14) of the damper device (14), having an input element (16), which, through an effect of a first energy storage element (18), is rotatable to a limited degree relative to an intermediate element (22) which is located after the input element (16) in a torque transfer path, while forming a first damper stage (20); and,
an output element (24) located after the intermediate element (22) in the torque transfer path, which is rotatable to a limited degree relative to the intermediate element (22) through an effect of a second energy storage element (26) while forming a second damper stage (28), wherein the damper device (11) or the first damper stage (20) and/or the second damper stage (28) is designed in such a way that the first damper stage (20) and/or the second damper stage (20) can essentially be short-circuited mechanically by means of a bridging.

23. A method for designing a damper device (11), in particular a torsional vibration damper (10), for a vehicle, preferably for a torque transfer device (10) or a converter of a motor vehicle, for transferring a torque between a drive side (12) and an output side (14) of the damper device (14), wherein below a certain transitional torque coming from the drive side (12) the damper device (11) is designed as a damper device (11) having two functional damper stages (20, 28), and above the certain transitional torque coming from the drive side (12) the damper device (11) is designed as a damper device (11) having a single functional damper stage (20).

24. A method for designing a damper device according to claim 23, wherein below the certain transitional torque of the drive side (12) the damper device (11) is conceived as a dual turbine device (11), and above the certain transitional torque of the drive side (12) as a single turbine damper device (11); a second damper stage (28) of the damper device (11) operates as a dual damper stage (28; 26, 38), and/or a first damper stage (20) of the damper device (11) as a dual damper stage (20); a dual damper stage (20/28; 26, 38) is realized using two difference energy storage elements (26, 38) in the relevant damper stage (20/28); the damper device (11) is designed for conventional operation of the vehicle with an internal combustion engine, operation of the vehicle with cylinder shut-off of the internal combustion engine, and/or operation of the vehicle with an electric motor.
